(19) United States
(12) Patent Application Publication
(10) Pub. No.: US 2018/0150257 A1
(43) Pub. Date: May 31, 2018

(54) File System Streams Support And Usage

(71) Applicant: Microsoft Technology Licensing, LLC, Redmond, WA (US)

(72) Inventors: Tristan C. Griffith, Seattle, WA (US); Rajsekhar Das, Kirkland, WA (US); Chesong Lee, Bellevue, WA (US); Daniel Chan, Redmond, WA (US); Ravinder S. Thind, Sammamish, WA (US)

(21) Appl. No.: 15/482,434

(22) Filed: Apr. 7, 2017

Related U.S. Application Data
(60) Provisional application No. 62/428,353, filed on Nov. 30, 2016.

(51) Int. Cl. G06F 3/06

(52) U.S. Cl. CPC G06F 3/0643; G06F 3/0673; G06F 3/0626

(57) ABSTRACT

A file system is provided with awareness of “streams” on an SSD to enable more efficient storage of files and other data on the SSD. The file system may be configured to receive a first request from an application to associate a file with a particular stream identifier available on a storage device, intercept one or more subsequent requests to write data to the file, associate the one or more subsequent requests with the stream identifier, and instruct a storage driver associated with the storage device to write the requested data to the identified stream.

### CROSS REFERENCE TO RELATED APPLICATIONS

This application claims the benefit of U.S. provisional application No. 62/428,353 filed on Nov. 30, 2016, which is incorporated herein by reference in its entirety.

### BACKGROUND

Solid state devices (SSDs), such as flash storage, offer many benefits over traditional hard disk drives (HDDs). For example, SSDs are often faster, quieter and draw significantly less power than their HDD counterparts. However, there are also numerous drawbacks associated with SSDs. For example, SSDs are limited in the sense that data can only be erased from the storage device in blocks, also known as “erase blocks.” These blocks may contain, in addition to data that a user wishes to erase, important data that the user wishes to keep stored on the SSD. In order to erase the unwanted data, the SSD must perform a process known as “garbage collection” in order to move data around on the SSD so that important files are not accidentally deleted. However, this process may result in an effect known as “write amplification” where the same data is written to the physical media on the SSD multiple times, shortening the lifespan of the SSD.

### SUMMARY

Disclosed herein are methods and systems for storing file data on an SSD in a way that is efficient and reduces the need for garbage collection. In one embodiment, a file system may be configured to receive a first request from an application to associate a file with a particular stream identifier available on a storage device, intercept one or more subsequent requests to write data to the file, associate the one or more subsequent requests with the stream identifier, and instruct a storage driver associated with the storage device to write the requested data to the identified stream. The file system may be further configured to store metadata associated with the file, the metadata comprising the stream identifier associated with the file. In addition, the file system may be configured to send to the application a plurality of stream parameters associated with the storage device. The file system may be further configured, prior to associating the file with the stream identifier, to validate the stream identifier.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects discussed. In the drawings:

FIG. 1 illustrates an example computing device, in which the aspects disclosed herein may be employed;

FIG. 2 illustrates an example solid state device (SSD);

FIGS. 3A-3D illustrate a process of garbage collection performed on the SSD;

FIG. 4 illustrates a process of streaming multiple erase blocks on a device, for example, on an SSD;

FIG. 5 illustrates a method of implementing streaming functionality on a device;

FIG. 6 illustrates an example architecture for implementing streaming functionality on a device;

FIG. 7 illustrates a method of enabling streams; and

FIG. 8 illustrates a method of discovering, associating, writing, disassociating, releasing, and deleting streams on a device.

### DETAILED DESCRIPTION

Disclosed herein are methods and systems for providing file system awareness of “streams on an SSD based, for example, to enable more efficient storage of files and other data. In one embodiment, a file system may be configured to receive a first request from an application to associate a file with a particular stream identifier available on a storage device, intercept one or more subsequent requests to write data to the file, associate the one or more subsequent requests with the stream identifier, and instruct a storage driver associated with the storage device to write the requested data to the identified stream.

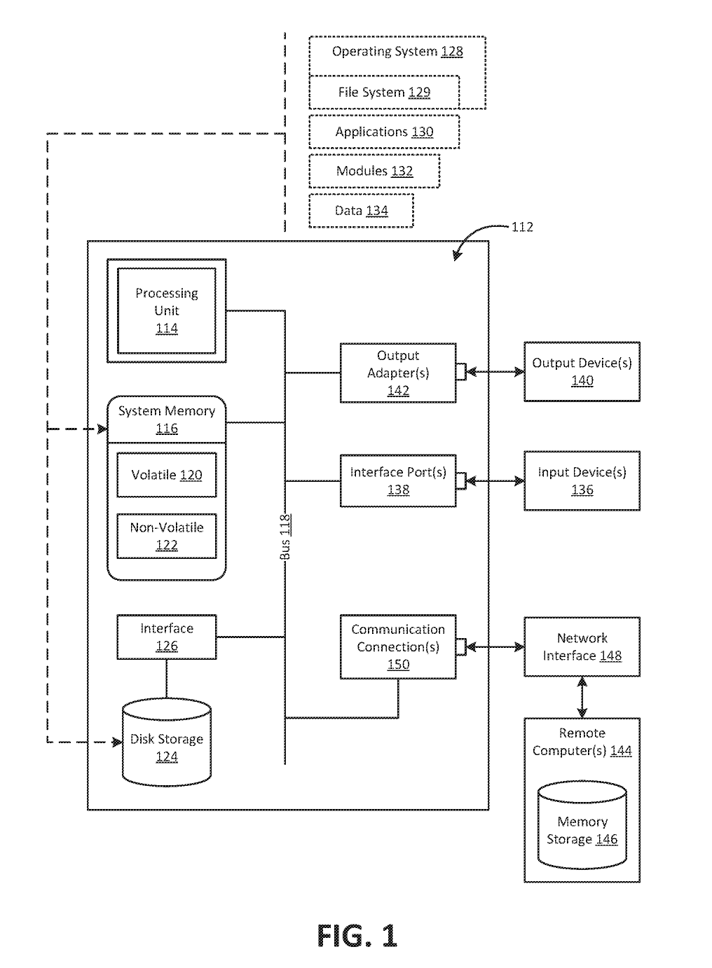

FIG. 1 illustrates an example computing device 112 in which the techniques and solutions disclosed herein may be implemented or embodied. The computing device 112 may be any one of a variety of different types of computing devices, including, but not limited to, a computer, personal computer, server, portable computer, mobile computer, wearable computer, laptop, tablet, personal digital assistant, smartphone, digital camera, or any other machine that performs computations automatically.

The computing device 112 includes a processing unit 114, a system memory 116, and a system bus 118. The system bus 118 couples system components including, but not limited to, the system memory 116 to the processing unit 114. The processing unit 114 may be any of various available processors. Dual microprocessors and other multiprocessor architectures also may be employed as the processing unit 114.

The system bus 118 may be any of several types of bus structure(s) including a memory bus or memory controller, a peripheral bus or external bus, and/or a local bus using any variety of available bus architectures including, but not limited to, Industry Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 116 includes volatile memory 120 and nonvolatile memory 122. The basic input/output system (BIOS), containing the basic routines to transfer information between elements within the computing device 112, such as during start-up, is stored in nonvolatile memory 122. By way of illustration, and not limitation, nonvolatile memory 122 may include read only memory (ROM), programmable ROM (PROM), electrically programmable ROM (EPROM), electrically erasable ROM (EEPROM), or flash memory. Volatile memory 120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computing device 112 also may include removable/non-removable, volatile/non-volatile computer-readable storage media. FIG. 1 illustrates, for example, a disk storage 124. Disk storage 124 includes, but is not limited to, devices like a magnetic disk drive, floppy disk drive, tape drive, Jaz drive, Zip drive, LS-100 drive, memory card (such as an SD memory card), or memory stick. In addition, disk storage 124 may include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 124 to the system bus 118, a removable or non-removable interface is typically used such as interface 126.

FIG. 1 further depicts software that acts as an intermediary between users and the basic computer resources described in the computing device 112. Such software includes an operating system 128. Operating system 128, which may be stored on disk storage 124, acts to control and allocate resources of the computing device 112. Applications 130 take advantage of the management of resources by operating system 128 through program modules 132 and program data 134 stored either in system memory 116 or on disk storage 124. It is to be appreciated that the aspects described herein may be implemented with various operating systems or combinations of operating systems. As further shown, the operating system 128 includes a file system 129 for storing and organizing, on the disk storage 124, computer files and the data they contain to make it easy to find and access them.

A user may enter commands or information into the computing device 112 through input device(s) 136. Input devices 136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 114 through the system bus 118 via interface port(s) 138. Interface port(s) 138 include, for example, a serial port, a parallel port, a game port, and a universal serial bus (USB). Output device(s) 140 use some of the same type of ports as input device(s) 136. Thus, for example, a USB port may be used to provide input to computing device 112, and to output information from computing device 112 to an output device 140. Output adapter 142 is provided to illustrate that there are some output devices 140 like monitors, speakers, and printers, among other output devices 140, which require special adapters. The output adapters 142 include, by way of illustration and not limitation, video and sound cards that provide a means of connection between the output device 140 and the system bus 118. It should be noted that other devices and/or systems of devices provide both input and output capabilities such as remote computer(s) 144.

Computing device 112 may operate in a networked environment using logical connections to one or more remote computing devices, such as remote computing device(s) 144. The remote computing device(s) 144 may be a personal computer, a server, a router, a network PC, a workstation, a microprocessor based appliance, a peer device, another computing device identical to the computing device 112, or the like, and typically includes many or all of the elements described relative to computing device 112. For purposes of brevity, only a memory storage device 146 is illustrated with remote computing device(s) 144. Remote computing device(s) 144 is logically connected to computing device 112 through a network interface 148 and then physically connected via communication connection 150. Network interface 148 encompasses communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 150 refers to the hardware/software employed to connect the network interface 148 to the bus 118. While communication connection 150 is shown for illustrative clarity inside computing device 112, it may also be external to computing device 112. The hardware/software necessary for connection to the network interface 148 includes, for exemplary purposes only, internal and external technologies such as modems including regular telephone grade modems, cable modems and DSL modems, ISDN adapters, and Ethernet cards.

As used herein, the terms “component,” “system,” “module,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

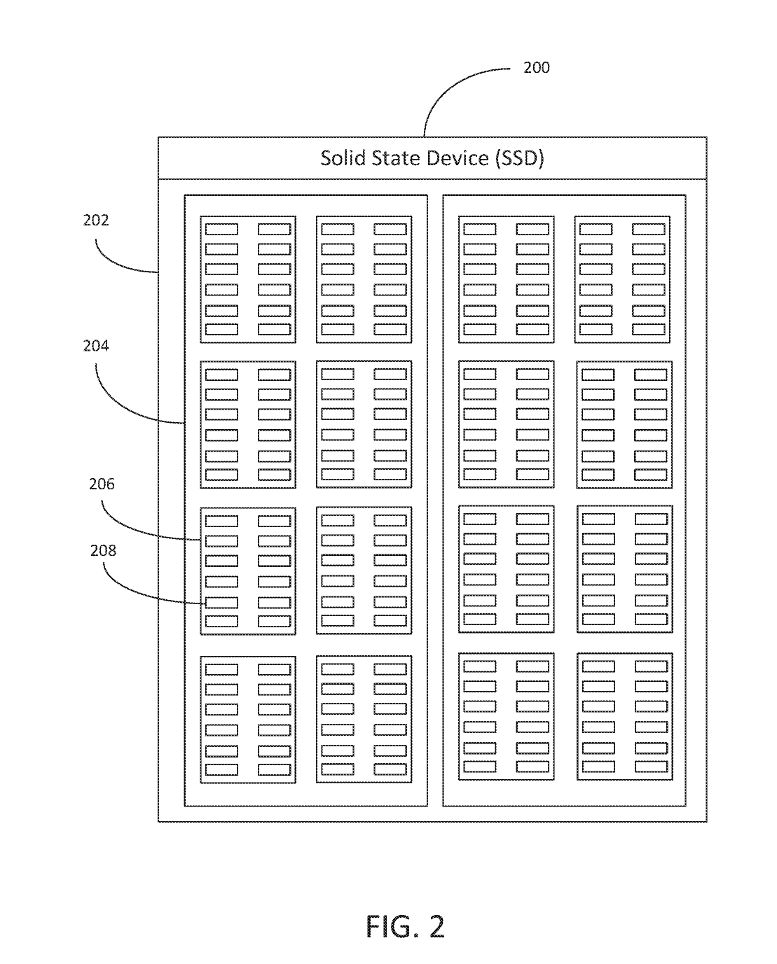

FIG. 2 illustrates an example solid state device (SSD) 200. The SSD illustrated in FIG. 2 may be, for example, a NAND flash storage device. The SSD 200 may, for example, be used to implement the secondary storage 124 of the example computing device shown in FIG. 1. As shown, the SSD may comprise a die 202. A die may represent the smallest unit of the SSD that can independently execute commands. While the SSD in FIG. 2 comprises only a single die, it is understood that an SSD may comprise any number of die. As further shown in FIG. 2, each die may comprise one or more planes 204. An SSD may typically comprise one or two planes, and concurrent operations may take place on each plane. However, it is understood that an SSD may comprise any number of planes. As further illustrated in FIG. 2, each plane 204 may comprise a number of blocks 206. A block may be the smallest unit of the SSD that can be erased. Blocks may also be referred to herein as “erase blocks.” Finally, as shown in FIG. 2, each block 206 may comprise a number of pages 208. A page may be the smallest unit of the SSD that can be programmed.

Program operations on the SSD, also known as “writes” or “write operations,” may be made to any given page on the SSD. A page may be, for example, about 4-16 KB in size, although it is understood that any size may be used. In contrast, erase operations may be only be made at the block level. A block may be, for example, about 4-8 MB in size, although it is understood that any size may be used. A controller associated with the SSD may manage the flash memory and interface with the host system using a logical-to-physical mapping system, for example, logical block addressing (LBA).

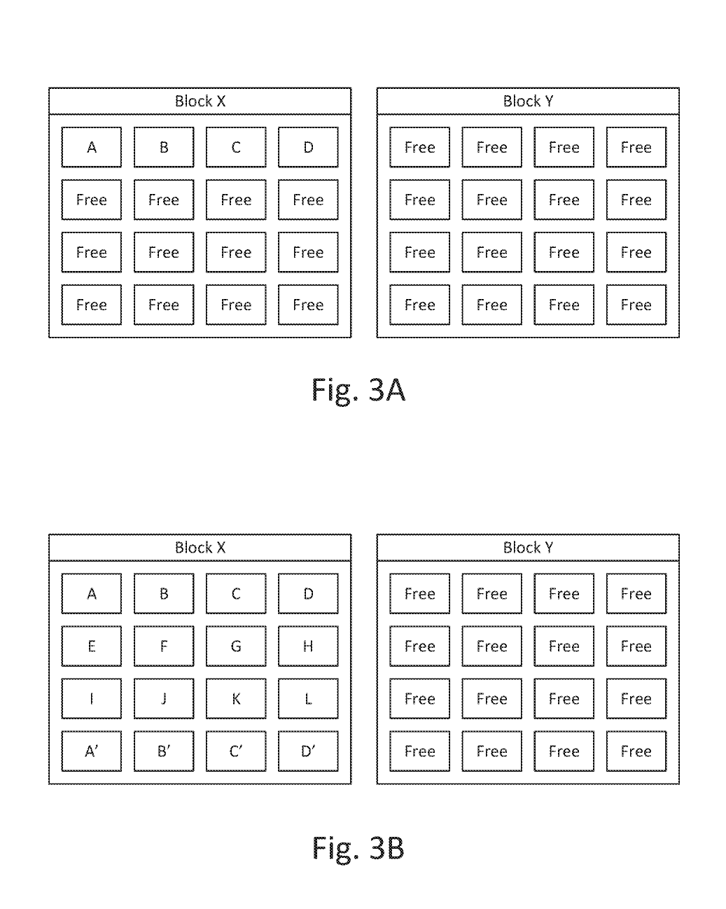

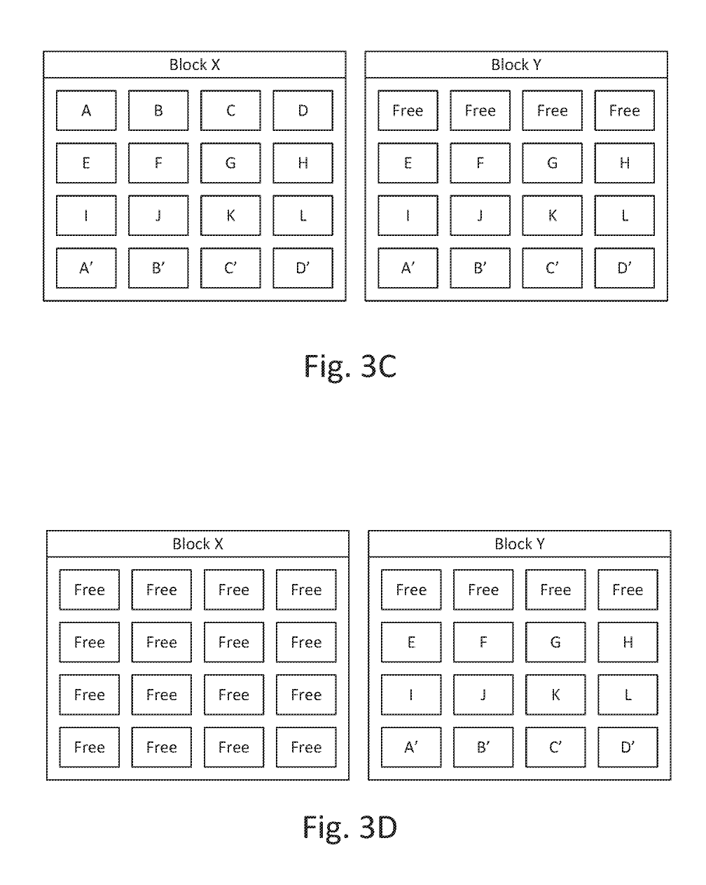

SSDs generally do not allow for data stored in a given page to be updated. When new or updated data is saved to the SSD, the controller may be configured to write the new or updated data in a new location on the SSD and to update the logical mapping to point to the new physical location. This new location may be, for example, a different page within the same erase block, as further illustrated in FIG. 3. At this point, the data in the old location may no longer be valid, and may need to be erased before the location can be written to again.

However, as discussed above, the old or invalid data may not be erased without erasing all of the data within the same erase block. For example, that erase block may contain the new or updated data, as well as other data that a user may wish to keep stored on the SSD. In order to address this issue, the controller may be configured to copy or re-write all of the data that is not intended to be deleted to new pages in a different erase block. This may be referred to herein as “garbage collection.” The new or updated data may be written directly to a new page or may be striped across a number of pages in the new erase block. This undesirable process by which data is written to the SSD multiple times as a result of the SSDs inability to update data is known as write amplification, and is further illustrated below in connection with FIG. 3. Write amplification presents a significant problem in SSD storage as SSDs can only be programmed and erased a limited number of times. This may be referred to herein as the number of program/erase cycles that the SSD can sustain.

As shown in FIG. 3A, an SSD may comprise two blocks: Block X and Block Y. It is understood that while the SSD illustrated in FIGS. 3A-3D comprises two blocks, an SSD may comprise any number of blocks. As discussed above, a block or “erase block” may comprise the smallest unit of the SSD that may be erased. Each of Block X and Block Y illustrated in FIGS. 3A-3D comprises sixteen pages, however, it is understood that a given block may comprise any number of pages. Data may be written directly to any one of the pages on Block X or Block Y. In addition, data may be striped across a plurality of pages associated with Block X or Block Y. As shown in FIG. 3A, data may be written to Page A, Page B, Page C and Page D associated with Block X, while the remaining pages of Block X may be left empty (free). Block Y may similarly be left empty.

As shown in FIG. 3B, additional data may be written to Block X at a later time via a write operation by the controller. Again, this write operation may comprise writing data directly to any one of the pages in Block X or Block Y or striping the data across a plurality of the pages. For example, data may be written directly to or striped across Page E, Page F, Page G, Page H, Page I, Page J, Page K and Page L associated with Block X. In addition, a user or application may wish to update the information stored at Pages A-D of FIG. 3A. However, as discussed above, the SSD may not allow for data to be updated. Thus, in order to store the new data, a controller associated with the SSD may be configured to execute a write operation to additional pages in Block X representing the updates to Pages A-D. These pages, as illustrated in FIG. 3B, may be labeled as Page A′, Page B′, Page C′ and Page D′. The data stored at Pages A′-D′ may represent any of minor or major updates to the data stored at Pages A-D.

As further illustrated in FIG. 3C, in order to perform a delete operation on the data stored at Pages A-D, and as further discussed above, the entirety of Block X may need to be erased. The controller associated with the SSD may be configured to copy or re-write important data on Block X that the user does not wish to be deleted to a different erase block, for example, Block Y. As illustrated in FIG. 3C, the controller may be configured to copy the data stored at Pages E-L as well as the data stored at Pages A′-D′ of Block X to Block Y.

As discussed above, this process of “updating” data to a new location may be referred to “garbage collection.” The process of garbage collection as illustrated in FIG. 3C may address the issue of erasing unwanted data while keeping important data stored on the device. However, this comes at the cost of copying and re-writing a single piece of data multiple times on the same SSD. For example, both Block X and Block Y of the SSD may contain copies of the data stored at Pages E-L as well as the data stored at Pages A′-D′. This undesirable process of re-writing multiple copies of the same data may be known as write amplification.

Finally, as shown in FIG. 3D, the controller may be configured to erase all of the data stored at Block X. As all of the important data intended to be kept on the SSD has been copied to Block Y, the entirety of Block X may be deleted by the controller. Once this process has completed, the controller may be configured to write new data to any of the pages in Block X. However, as discussed above, this process of write amplification presents a significant problem in SSD storage as an SSD may only be programmed and erased a limited number of times. For example, in the case of a single level flash, the SSD may be written to and erased a maximum of 50,000-100,000 times.

One additional feature associated with SSD storage is the over-provisioning of storage space. Over-provisioning may be represented as the difference between the physical capacity of the flash memory and the logical capacity presented through the operating system as available for the user. During, for example, the process of garbage collection, the additional space from over-provisioning may help lower the write amplification when the controller writes to the flash memory. The controller may use this additional space to keep track of non-operating system data such as, for example, block status flags. Over-provisioning may provide reduced write amplification, increased endurance and increased performance of the SSD. However, this comes at the cost of less space being available to the user of the SSD for storage operations.

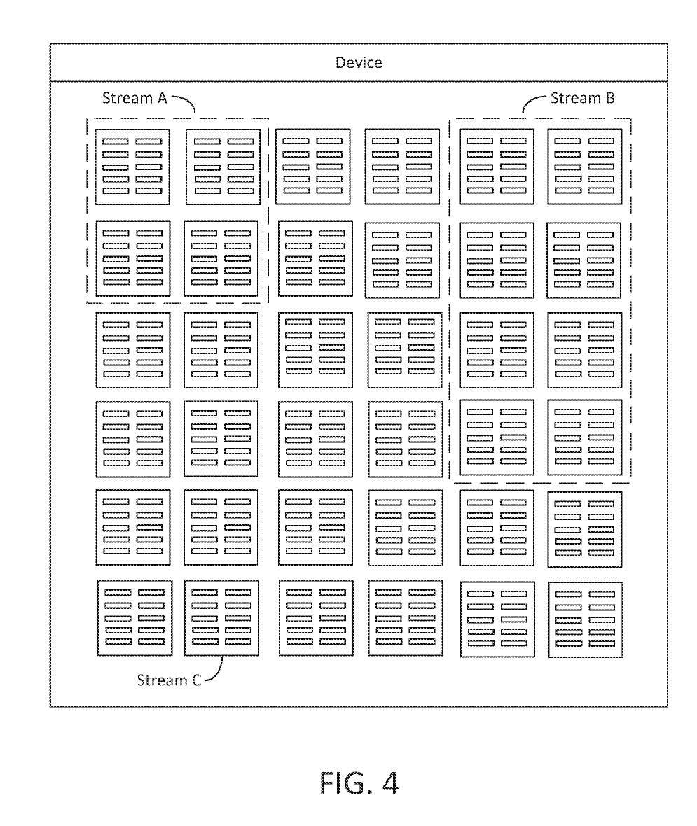

Solid state devices may support functionality known as “streaming” by which data may be associated with a particular stream based, for example, on an estimated deletion time of the data, in order to reduce the problems associated with write amplification and over-provisioning. A stream, as discussed herein, may comprise one or more erase blocks. The process of streaming SSDs may comprise, for example, instructing the SSD to associate a bunch of data together in the same erase block or group of erase blocks (i.e., in the same “stream”) because it is likely that all of the data will be erased at the same time. Because data that will be deleted together will be written to or striped across pages in the same erase block or group of erase blocks, the problems associated with write amplification and over-provisioning can be greatly reduced. The process of streaming SSDs may be further illustrated as shown in connection with FIG. 4.

As shown in the example of FIG. 4, data may be grouped together in one or more erase blocks based, for example, on an estimated erase time of the data stored at each of the erase blocks. The controller may organize the one or more erase blocks such that data in each of the erase blocks may be erased together. This organization of data into one or more erase blocks based, for example, on an estimated deletion time of the data in the one or more erase blocks, may be referred to herein as “streaming.” As shown in FIG. 4, four erase blocks may be associated with Stream A, eight erase blocks may be associated with Stream B, and a single erase block may be associated with Stream C. The controller may be configured, for example, to perform all write operations of data that may be erased within two months to Stream A, all write operations of data that may be erased within two weeks to Stream B, and all write operations of data that may be erased within two days to Stream C. In another example, the controller may be configured to perform write operations to Stream A that may be erased upon the occurrence of an event that would result in all of the data written to Stream A being “updated” and subsequently marked as invalid.

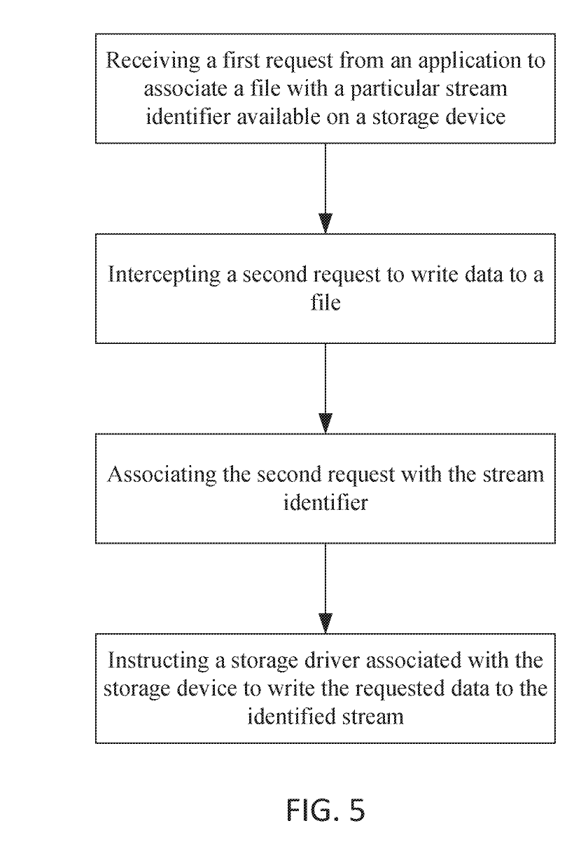

Methods and systems disclosed herein may provide a file system and a storage driver with awareness of the “streaming” capability of an SSD in order to enable the file system and/or an application to take advantage of the streaming capability for more efficient storage. For example, as illustrated in FIG. 5, a file system may be configured to receive a first request from an application to associate a file with a particular stream identifier available on a storage device, intercept one or more subsequent requests to write data to the file, associate the one or more subsequent requests with the stream identifier, and instruct a storage driver associated with the storage device to write the requested data to the identified stream. The file system may be further configured to store metadata associated with the file, the metadata comprising the stream identifier associated with the file. In addition, the file system may be configured to send to the application a plurality of stream parameters associated with the stream. The file system may be further configured, prior to associating the file with the stream identifier, to validate the stream identifier.

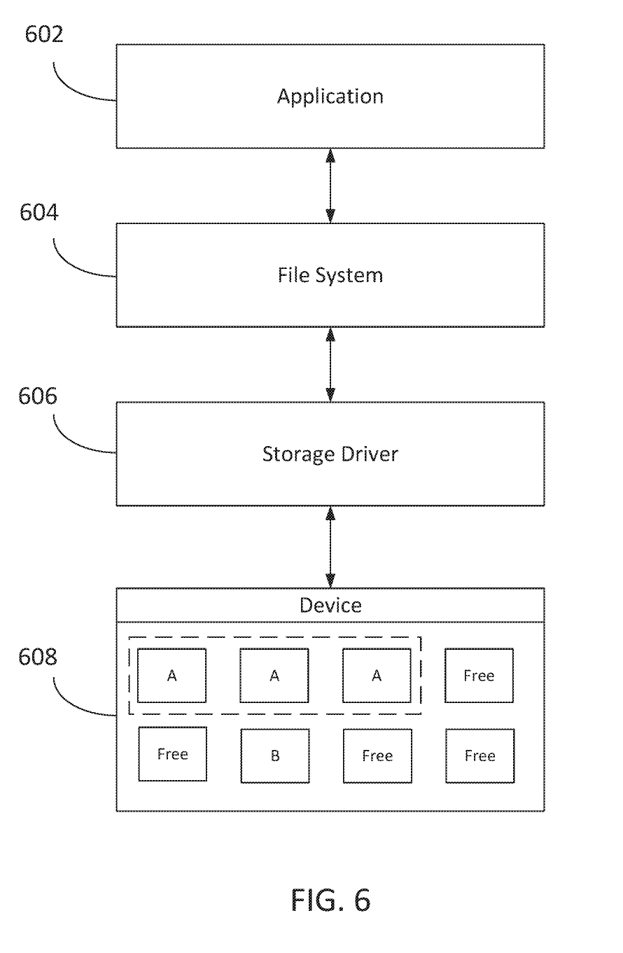

FIG. 6 is a block diagram illustrating example components of an architecture for implementing the streaming SSD functionality disclosed herein. As shown, in one embodiment, the architecture may comprise an application 602, a file system 604, a storage driver 606, and a device 608.

The application 602 may be configured to read and write files to the device 608 by communicating with the file system 604 and the storage driver 606. In order to take advantage of writing to a stream on the SSD, the application 602 must instruct the file system which ID to associate with a given file. The application 602 may be configured to instruct the file system which ID goes with the given file based, for example, on a determination that all of the data within the erase block that the file is located may be deleted at the same time. In one embodiment, multiple erase blocks may be tagged with a particular stream ID. For example, using the device illustrated in FIG. 6, multiple erase blocks may be associated with Stream A, and data may be written directly to a given one of the erase blocks or striped across multiple pages associated with the erase blocks in Stream A. In addition, Stream B may comprise a single erase block, and data may be written to a given one of the pages or striped across multiple pages associated with the erase block associated with Stream B. The data associated with Stream A may have a different estimated deletion time than the data associated with Stream B.

The file system 604 may be configured to expose an application programming interface (API) to the application 602. For example, the application 602, via an API provided by the file system 604, may be configured to tag a file with a particular stream ID. In addition, the application 602, via an API provided by the file system 604, may be configured to perform stream management, such as, for example, determining how many streams can be written to simultaneously, what stream IDs are available, and the ability to close a given stream. Further, the application 602, via an API provided by the file system 604, may be configured to determine a number of parameters associated with the stream such as, for example, the optimal write size associated with the stream.

The file system 604 may be further configured to intercept a write operation by the application 602 to a file in the device 608, determine that the file is associated with a particular stream ID with the file, and to tag the write operation (i.e., 110 call) with the stream ID. The file system 604 may be further configured to store metadata associated with each file of the device 608, and to further store the particular stream ID associated with each file along with the file metadata.

The storage driver 606 may be configured to expose an API to the file system 604. For example, the file system 604, via an API provided by the storage driver 606, may be configured to enable stream functionality on the storage device 608. The file system 604, via an API provided by the storage driver 606, may be further configured to discover existing streams on the device 608. The file system 604, via an API provided by the storage driver 606, may be further configured to obtain information from the device such as, for example, the ability of the device to support streams and what streams, if any, are currently open on the device. The storage driver 606 may be configured to communicate with the device 608 and to expose protocol device agnostic interfaces to the file system 604 so that the storage driver 606 may communicate with the device 608 without the file system 604 knowing the details of the particular device.

The device 608 may comprise, for example, an SSD. The SSD illustrated in FIG. 6, for example, comprises eight erase blocks. Data may be written individually to a given erase block or may be striped across a plurality of the erase blocks in order to maximize throughput on the SSD. As also shown in 608, and as further discussed herein, the plurality of erase blocks may be organized in streams such that data can be erased in a more efficient manner. For example, the SSD illustrated in FIG. 6 comprises Stream A which is associated with three erase blocks and Stream B which is associated with a single erase block.

Streams, as discussed herein, may be identifier-based. A host or a controller may be configured to use an arbitrary identifier, for example, an identifier in the 1h-FFFFh range, to identify a given stream. Some parameters to consider in identifying a given stream may comprise the optimal write size associated with the stream, the stream size granularity, the maximum stream limit (“Max Streams” limit), the stream resources available, the stream resources allocated, and the streams opened on the device. Stream resources may be managed by the host or by a controller associated with the device. In one embodiment, the stream resources and identifiers may be lost on reset or powering down of the device. In addition, the SSD may be configured such that there may be a mix of stream and non-stream writes to the SSD, as further discussed herein.

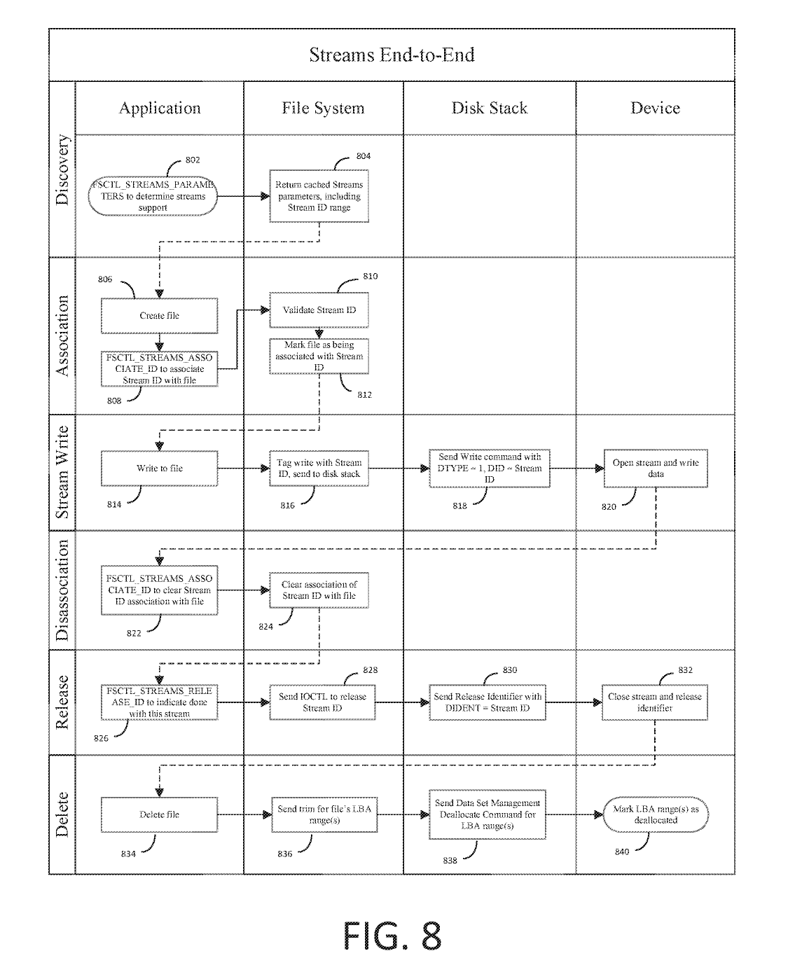

As discussed herein, in order for the file system to implement streams on a given device, the file system may be configured with a plurality of file system APIs. A number of these APIs are listed below and discussed further in connection with FIG. 8.

FSCTL_STREAMS_PARAMETERS: may be used by the file system in the stream discovery process. For example, this API may be used by the by the file system to determine the optimal write size, the stream granularity size, the Stream ID Min and the Stream ID Max of a given stream. If the request is successful, then the Streams functionality may be supported by the file system. However, if the request is not successful, the file system may return an ERROR_NOT_SUPPORTED message. The file system may set the Stream ID Max value based on a Max Concurrent Streams value obtained from the disk stack. The disk stack may also be referred to herein as the storage driver. The file system may be configured to validate the stream IDs, and may allocate streams for itself and expose the remaining streams to the application.

IOCTL_STORAGE_STREAMS_PARAMETERS: may be used by the disk stack in the stream discovery process. This API may be used in determining the minimum write size, the optimal write size, the stream granularity size, the max number of concurrent streams, the Stream ID Min, the Stream ID Max, the trim granularity size, the number of streams allocated to the given device, the open stream count and the total stream resources available on the device (this should be equal to the number of allocated streams) by the disk stack. If the API is successful, then streams may be supported by the SSD. If the API request is not successful, then the disk stack may return a STATUS_NOT_SUPPORTED message to indicate that the device does not support streams. StorNVMe may not be able to enable streams until the first instance of this IOCTL is sent.

IOCTL_STORAGE_STREAMS_GET_OPEN_STREAMS: may be used to determine the open stream count and the array of stream IDs that are currently open.

FSCTL_STREAMS_PARAMETERS: may be a file system stream ID API that is used to determine the Stream ID Min and the Stream ID Max fields to give the range of stream IDs that the application can use.

FSCTL_STREAMS_ASSOCIATE_ID: may be a file system Stream ID API that is used to associate a stream ID with a given file. A “set” command may associate a given stream ID with a given file. Any subsequent writes to that file may be tagged as a stream write with the given stream ID. A “clear” command may disassociate the Stream ID with the file so that subsequent writes to the file may no longer be stream writes.

FSCTL_STREAMS_RELEASE_ID: may be a file system stream ID API that releases a given stream ID. This may be implemented to let the device know that a given stream ID is no longer being used and allows the device to free up those resources.

IOCTL_STORAGE_STREAMS_RELEASE_ID: may be a stream ID release disk stack API that may cause the stream ID to be released. This API may return a success indicator unless streams are not supported by the device. The corresponding stream may be closed and associated stream IDs no longer valid. Upon execution of this API, the stream ID may no longer refer to the same physical erase block. The next write to the device with that stream ID may be to a different erase block.

Although the various API calls discussed above are identified by particular names, such as FSCTL_STREAMS_PARAMETERS, it is understood that these names are merely examples and that these API functions may have different names of formats in other embodiments.

When an application deletes a file, a command (which in some embodiments may comprise a trim command) may be sent from the file system to give the storage device a hint that the file's LBAs are no longer in use. On a device that supports streams, there may be some additional considerations. For example, the trim command may have a specific alignment requirement. In addition, the application may want to release the Stream ID after file deletion if it has no further use for that stream.

It is possible that something may happen at the device level that causes all of the current stream state information to be lost. For example, this may result from a controller reset or a power cycle. The disk stack may be configured to detect when this happens and re-enable or initialize streams on the device, log an ETW event, or raise a PNP notification so that the file system may be aware of when this happens and take any necessary actions.

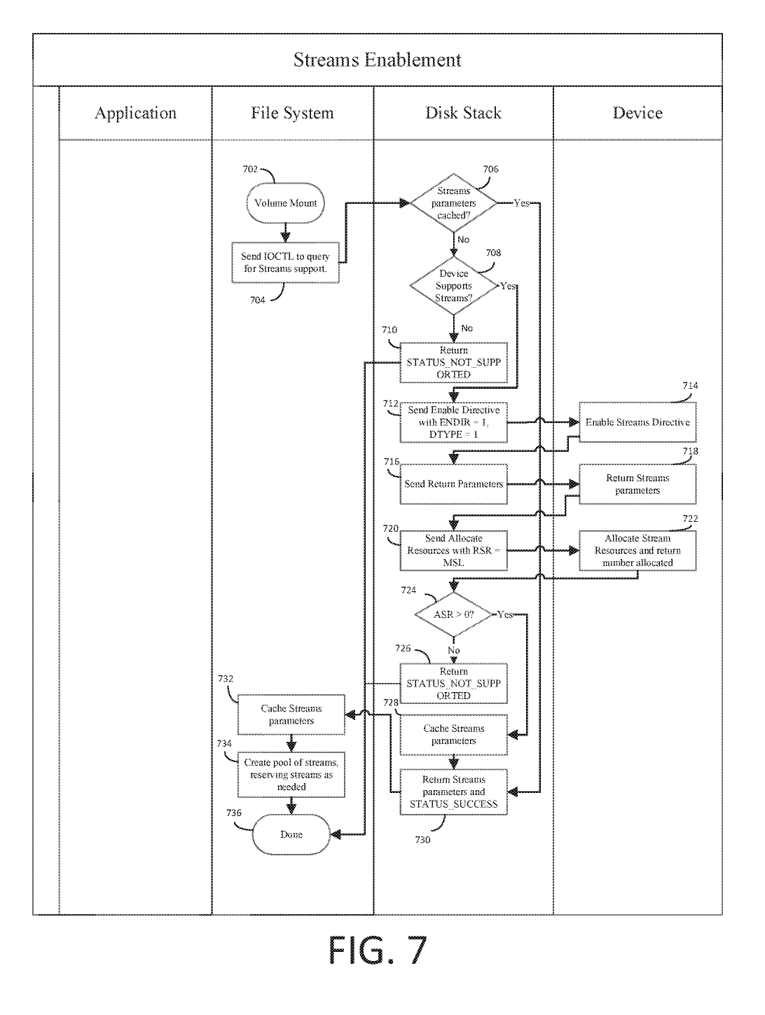

In order for a device, such as a solid state device, to use streams as discussed herein, stream functionality must be enabled by the file system and the storage driver. The methods and systems disclosed herein may provide the functionality for a device to associate a file with a particular stream ID and to write data to a particular stream associated with the stream ID on the storage device. In other words, the methods and systems disclosed herein may provide host awareness of the streaming process. An exemplary process for enabling the streams functionality is illustrated in FIG. 7.

The processes illustrated in FIGS. 7 and 8, and discussed further below, are described in the context of an example implementation that utilizes NVMe-specific protocols. However, it is understood that the processes disclosed herein are not limited to this example implementation. Rather, the methods disclosed herein may be implemented in other embodiments using, for example, SATA, SCSI, or any other suitable storage devices.

As shown at step 702 of FIG. 7, the file system may be configured to initiate a volume mount. Initiating the volume mount may comprise enabling streams and configuring resource allocation. The file system may be further configured to send an input/output control call (IOCTL) to the disk stack to query for streams support, as shown at step 704.

As shown at step 706 of FIG. 7, upon receiving the IOCTL from the file system, the disk stack may be configured to determine whether the streams parameters are cached on the disk stack. If the Stream parameters are cached, the disk stack may be configured to return Streams parameters and a STATUS_SUCCESS indicator to the file system, as shown at step 730 of FIG. 7. If the Streams parameters are not cached, the disk stack may be configured to determine if the device supports streams, as shown at step 708. If the disk stack determines that the device does not support streams, as shown at step 710, then the disk stack will return a STATUS_NOT_SUPPORTED indicator to the file system and take no further action, as indicated at stop 736. However, as shown at step 712, if the disk stack determines that the device does support streams, then the disk stack will send to the device a command to enable the streaming capabilities of the device, if necessary. For example, as shown at step 712 of FIG. 7, in an NVMe specific protocol, this may comprise sending an Enable Directive command with ENDIR=1 and directive type (DTYPE)=1 to the device.

Upon receiving the command to enable streaming capabilities from the disk stack, the device may be configured to enable streams, as indicated at step 714 of FIG. 7. As shown at steps 716 and 718, upon receiving an indication that the streams directive have been enabled, the disk stack may be configured to send another command to obtain the streams parameters from the device. The disk stack may be configured to allocate the maximum number of stream resources supported. As shown at step 720, the disk stack may then be configured to send to the device a command that the device may allocate stream resources for use by the disk stack. As shown at step 720 of FIG. 7, in an NVMe specific protocol, this indicator may comprise an Allocate Resources command with RSR=MSL to the device. Upon receiving the Allocate Resources command from the disk stack, the device may be configured to allocate stream resources and return the number allocated to the disk stack, as illustrated at step 722 of FIG. 7.

The disk stack may be further configured to determine if at least one stream resource has been allocated to the disk stack, as shown at step 724 of FIG. 7. In an NVMe specific protocol, determining if at least one resource has been allocated to the disk stack may comprise, as shown at step 724, determining if the ASR value is greater than 0. If the disk stack determines that no stream resource has been allocated to the disk stack, then the disk stack may be configured to return a STATUS_NOT_SUPPORTED indicator to the file system and to take no further action, as shown at step 726. In an NVMe specific protocol, this may comprise determining that the ASR value is not greater than 0. However, if the disk stack determines that at least one stream resource has been allocated to the disk stack, than the disk stack may be configured to cache the streams parameters, as shown at step 728. In an NVMe specific protocol, this may comprise determining that the ASR value is greater than 0. Upon caching the streams parameters, as shown at step 730, the disk stack may be configured to return the screams parameters and a STATUS_SUCCESS indicator to the file system.

The file system, as shown at step 732 of FIG. 7, may be further configured to cache the stream parameters upon receiving the STATUS_SUCCESS indicator from the disk stack. The file system may be further configured to create a pool of streams, reserving the streams as needed, as indicated at step 734. The file system may be configured to reserve one or more stream resources to itself before passing parameters to the application. The application may further be configured to send the FSCTL_STREAMS_PARAMETERS API to discover stream support and parameters. Once the streams have been enabled, the application, file system, disk stack and device may be configured to utilize the streaming process as further demonstrated in connection with FIG. 8.

As shown in FIG. 8, the streaming process may comprise a number of phases, including discovery, association, stream write, disassociation, release and deletion of the file and the associated Stream ID.

In order for the application and the file system to discover a particular Stream ID, as shown at step 802 of FIG. 8, the application may be configured to initiate a file system control call (FSCTL) to determine whether the device supports stream functionality. This call may be in the form of a FSCTL_STREAMS_PARAMETERS call, as discussed above. The application may be configured to send this control call to the file system. The file system, upon receiving the FSCTL_STREAMS_PARAMETERS call, may be configured to return cached Streams parameters, including a Stream ID range, to the application, as shown at step 804. The discovery process illustrated at steps 802 and 804 of FIG. 8 are discussed further in connection with FIG. 7.

The Stream ID may further be associated with a particular file, as shown at steps 806-812 of FIG. 8. As shown at step 806, the application may be configured to create a file. The application may be further configured to associate a particular stream ID with the file, as shown at step 808 of FIG. 8. This may be done via a file system control call in the form of FSCTL_STREAMS_ASSOCIATE_ID sent to the file system, as discussed above. As shown at step 810, the file system may be configured to validate the stream ID received from the application. The file system may be further configured to mark the file as being associated with the stream ID, as shown at step 812.

The application, file system, disk stack and device may be further configured to write data to a particular stream on the device. Upon receiving an indication from the file system that the file has been associated with the Stream ID, the application may be configured to write to the file, as shown at step 814 of FIG. 8. As shown at step 816, the file system may then be configured to tag the write with the Stream ID, and send the write with the associated tag to the disk stack. Upon receiving the write with the associated Stream ID from the file system, the disk stack may be configured to send a write command to the SSD, as shown at step 818. In an NVME specific protocol, sending a write command may comprise sending an indication that the Directive Type (DTYPE)=1 and that the Directive ID (DID)=Stream ID. As shown at step 820, the device may then be configured to open the stream and write data to the device.

The file system and the application may be further configured to disassociate the stream ID and the file, for example, when the stream is no longer needed, as illustrated at steps 822-824 of FIG. 8. For example, at step 822, the application may be configured to initiate a file systems control call to indicate that the Stream ID should be disassociated with the file. The file system control call may be in the form of FSCTL_STREAMS_ASSOCIATE_ID, as discussed above. Upon receiving the file system control call, the file system may be configured to clear any association of the Stream ID with the file, as shown at step 824.

As shown at steps 826-832 of FIG. 8, the Stream ID may be released upon disassociation of the Stream ID with any particular files. For example, as shown at step 826, the application may be configured to initiate a file system control call in order to indicate that the application is done with the particular stream. This file system control call may be in the form of FSCTL_STREAMS_RELEASE_ID, as discussed above. Upon receiving the file system control call, the file system may be configured to send an input/output control call (IOCTL) to release the stream ID, as shown at step 828. As shown at step 830, the disk stack may be configured to send to the device a command instructing the device to release the stream ID. In an NVMe specific protocol, this may comprise sending to the device a Release Identifier Command with DIDENT=Stream ID. Finally, as shown at step 832, the device may be configured to close the stream and to release the stream identifier.

As further shown in FIG. 8, the file may be deleted as shown in connection with steps 834-840. As shown at step 834, the application may be configured to delete the file. At step 836, the file system may be configured to send a trim command for the files logical block addressing (LBA) ranges. A trim command may enable the operating system to instruct a device, such as the SSD illustrated in FIG. 8, which blocks of previously saved data are no longer needed and may be deleted. As shown at step 838, the disk stack may be configured to send a data management deallocation command for the given LBA ranges. Finally, as shown at step 840, the device may be configured to mark the LBA ranges as deallocated.

In addition, the file system may be configured to reserve a number of streams for itself as the file system may wish to take advantage of the streaming process in order to efficiently write data for the stream IDs.

The illustrations of the aspects described herein are intended to provide a general understanding of the structure of the various aspects. The illustrations are not intended to serve as a complete description of all of the elements and features of apparatus and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The various illustrative logical blocks, configurations, modules, and method steps or instructions described in connection with the aspects disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the present disclosure.

The various illustrative logical blocks, configurations, modules, and method steps or instructions described in connection with the aspects disclosed herein, or certain aspects or portions thereof, may be embodied in the form of computer executable instructions (i.e., program code) stored on a computer-readable storage medium which instructions, when executed by a machine, such as a computing device, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any non-transitory (i.e., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computer.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

The description of the aspects is provided to enable the making or use of the aspects. Various modifications to these aspects will be readily apparent, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed:

1. A method comprising:
receiving a first request from an application to associate a file with a particular stream identifier available on a storage device;
intercepting one or more subsequent requests to write data to the file;
associating the one or more subsequent requests with the stream identifier; and
instructing a storage driver associated with the storage device to write the requested data to the identified stream.

2. The method of claim 1, further comprising storing metadata associated with the file, the metadata comprising the stream identifier associated with the file.

3. The method of claim 1, further comprising sending, to the application, a plurality of stream parameters associated with the stream.

4. The method of claim 1, further comprising, prior to associating the file with the stream identifier, validating the stream identifier.

5. The method of claim 1, wherein the stream identifier is associated with one or more erase blocks on the storage device.

6. The method of claim 1, wherein one or more files are associated with the stream identifier based on an estimated erase time of the data in the one of more files associated with the stream identifier.

7. The method of claim 1, further comprising, prior to intercepting the one or more subsequent requests to write data to the file, determining that the storage device supports streaming capabilities.

8. A computing device comprising a processing unit, a memory, and a file system executing on the processing unit, the file system when executing on the processing unit performing operations comprising:
receiving a first request from an application to associate a file with a particular stream identifier available on a storage device;
intercepting one or more subsequent requests to write data to the file;
associating the one or more subsequent requests with the stream identifier; and
instructing a storage driver associated with the storage device to write the requested data to the identified stream.

9. The computing device of claim 8, wherein the file system performs additional operations comprising storing metadata associated with the file, the metadata comprising the stream identifier associated with the file.

10. The computing device of claim 8, wherein the file system performs additional operations comprising sending, to the application, a plurality of stream parameters associated with the stream.

11. The computing device of claim 8, wherein the file system performs additional operations comprising, prior to associating the file with the stream identifier, validating the stream identifier.

12. The computing device of claim 8, wherein the stream identifier is associated with one or more erase blocks on the storage device.

13. The computing device of claim 8, wherein one or more files are associated with the stream identifier based on an estimated erase time of the data in the one of more files associated with the stream identifier.

14. The computing device of claim 8, wherein the file system performs additional operations comprising, prior to intercepting the one or more subsequent requests to write data to the file, determining that the storage device supports streaming capabilities.

15. A computer readable storage medium on which computer-executable instructions are stored which, when executed by a computing device, cause the computing device to perform operations comprising:
receiving a first request from an application to associate a file with a particular stream identifier available on a storage device;
intercepting one or more subsequent requests to write data to the file;
associating the one or more subsequent requests with the stream identifier; and
instructing a storage driver associated with the storage device to write the requested data to the identified stream.

16. The computer readable storage medium recited in claim 15, the computer-executable instructions further causing the computing device to perform operations comprising storing metadata associated with the file, the metadata comprising the stream identifier associated with the file.

17. The computer readable storage medium recited in claim 15, the computer-executable instructions further causing the computing device to perform operations comprising sending, to the application, a plurality of stream parameters associated with the stream.

18. The computer readable storage medium recited in claim 15, the computer-executable instructions further causing the computing device to perform operations comprising, prior to associating the file with the stream identifier, validating the stream identifier.

19. The computer readable storage medium recited in claim 15, wherein the stream identifier is associated with one or more erase blocks on the storage device.

20. The computer readable storage medium recited in claim 15, wherein one or more files are associated with the stream identifier based on an estimated erase time of the data in the one of more files associated with the stream identifier.
